(19) United States
(12) Patent Application Publication
(10) Pub. No.: US 2026/0267019 A1
(43) Pub. Date: Sep. 10, 2026

(54) METHODS AND SYSTEMS FOR IDENTIFICATION AND TRACING OF RADIATION DETECTOR STRUCTURES

(71) Applicant: REDLEN TECHNOLOGIES, INC., Saanichton (CA)

(72) Inventors: Niloofar SADEGHI, Victoria (CA); Sanjay RAJGURU, Sydney (CA); Krzysztof INIEWSKI, Port Moody (CA)

(21) Appl. No.: 19/550,934

(22) Filed: Feb. 26, 2026

Related U.S. Application Data
(60) Provisional application No. 63/767,209, filed on Mar. 5, 2025.

(51) Int. Cl. G01T 7/00; G01T 1/24

(52) U.S. Cl. CPC G01T 7/005; G01T 1/247

(57) ABSTRACT

A method of generating an identifier for a radiation detector structure including an application specific integrated circuit (ASIC) includes performing a calibration process to determine threshold voltage offsets for a plurality of analog to digital converters (ADCs) in respective signal processing channels of the ASIC, generating the identifier for at least one of the ASIC or the radiation detector structure based on the threshold voltage offsets of the plurality of ADCs, and storing the identifier.

### FIELD

The present disclosure relates generally to imaging devices, and more specifically to methods and systems for uniquely identifying components of imaging device detectors, such as application specific integrated circuits (ASICs) used in the read-out circuitry of the imaging device detectors.

### BACKGROUND

Room temperature pixelated radiation detectors made of semiconductors, such as cadmium zinc telluride (Cd₁₋ₓZnₓTe where 0<x<1, or “CZT”), are gaining popularity for use in medical and non-medical imaging. These applications use the high energy resolution and sensitivity of the radiation detectors.

### SUMMARY

According to an aspect of the present disclosure, a method of generating an identifier for a radiation detector structure including an application specific integrated circuit (ASIC) includes performing a calibration process to determine threshold voltage offsets for a plurality of analog to digital converters (ADCs) in respective signal processing channels of the ASIC, generating the identifier for at least one of the ASIC or the radiation detector structure based on the threshold voltage offsets of the plurality of ADCs, and storing the identifier.

According to another aspect of the present disclosure, a radiation detector structure comprises at least one radiation sensor comprising an array of pixel detectors; an application specific integrated circuit (ASIC) comprising a plurality of signal processing channels, wherein: each of the signal processing channels contains an analog to digital converter (ADC), the plurality of signal processing channels of the ASIC are electrically coupled to respective pixel detectors of the array of pixel detectors, and each signal processing channel is configured to generate photon count data for a respective pixel detector of the array of pixel detectors; and a storage device configured to store an identifier for the radiation detector structure. The identifier is generated by performing a calibration process to determine threshold voltage offsets for a plurality of the ADCs in the respective signal processing channels of the ASIC, and generating the identifier for at least one of the ASIC or the radiation detector structure based on the threshold voltage offsets of the plurality of ADCs.

### BRIEF DESCRIPTION OF THE DRAWINGS

FIGS. 1A and 1B are functional block diagrams of an X-ray imaging system in accordance with various embodiments of the present disclosure.

FIG. 2A schematically illustrates a radiation detector including a pixelated radiation sensor coupled to a detector application specific integrated circuit (ASIC) according to various embodiments of the present disclosure.

FIG. 2B is a schematic block diagram illustrating a signal processing chain architecture of a detector ASIC for one channel of a spectral photon counting (SPC) radiation detector according to various embodiments of the present disclosure.

FIG. 2C is a schematic block diagram illustrating an alternative signal processing channel architecture of a detector ASIC for one channel of a spectral photon counting (SPC) radiation detector according to various embodiments the present disclosure.

FIGS. 3A-3C are side cross-section views illustrating radiation detector units having different architectures for integrating radiation sensors and ASICs according to various embodiments of the present disclosure.

FIGS. 4A and 4B are plots that schematically illustrate an example calibration process for applying corrections to the analog to digital converters (ADCs) of an ASIC according to various embodiments of the present disclosure.

FIG. 5 is a top view of a radiation detector unit including an n x m array of pixel detectors according to an embodiment of the present disclosure.

FIG. 6A is a table showing ADC offset correction values listed based on their pixel location according to various embodiments of the present disclosure.

FIG. 6B is a table showing pixel locations listed based on a ranking of their ADC offset correction values from lowest-to-highest according to various embodiments of the present disclosure.

FIG. 7 is a flow diagram illustrating a method for generating an identifier for a radiation detector structure including an ASIC according to various embodiments of the present invention.

### DETAILED DESCRIPTION

Embodiments of the present disclosure provide methods and systems for uniquely identifying components of imaging device detectors, such as application specific integrated circuits (ASICs) used in the read-out circuitry of the imaging device detectors, the various aspects of which are described herein with reference to the drawings.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims. Any reference to claim elements in the singular, for example, using the articles “a,” “an,” or “the” is not to be construed as limiting the element to the singular. The terms “example,” “exemplary,” or any term of the like are used herein to mean serving as an example, instance, or illustration. Any implementation described herein as an “example” is not necessarily to be construed as preferred or advantageous over another implementation. The drawings are not drawn to scale. Multiple instances of an element may be duplicated where a single instance of the element is illustrated, unless absence of duplication of elements is expressly described or clearly indicated otherwise.

Ionizing radiation detectors, such as X-ray detectors, typically include a radiation-sensitive sensor material that is operatively coupled to detector read-out electronics. In most modern radiation detectors, the detector read-out electronics include at least one semiconductor integrated circuit (IC), such as an application specific integrated circuit (ASIC) (which may also be referred to as a read out integrated circuit, or ROIC). Ionizing radiation detectors generally fall within two broad categories: energy integrating (EI) detectors and photon counting (PC) detectors. In EI detectors, the radiation-sensitive sensor material is commonly a solid-state scintillator material that is coupled to a photodiode. The scintillation light generated by the sensor material is proportional to both the energy of each photon incident on the sensor material as well as the number of incident photons per unit time. The photodiode converts the scintillation light to an electric signal that is amplified and integrated by the read-out electronics to produce the output signal.

In contrast, in a photon counting (PC) detector, the sensor material is typically a semiconductor material, such as cadmium telluride (CdTe), cadmium zinc telluride (CZT), silicon (Si), gallium arsenide (GaAs), etc., that is configured to directly detect photon interactions occurring within the sensor material. Photon interactions within the sensor material produce a cloud of charge carriers (e.g., via the photoelectric effect). A bias voltage applied to the sensor material produces an electric field that causes the charge carriers produced by the photon interactions to be swept towards electrodes located on opposite sides of the sensor material. The charge that is received at the electrodes produces a signal that may be amplified and converted into a voltage signal by the detector read-out electronics. The read-out electronics may additionally include a “comparator” that compares the amplitude of the voltage signal to a pre-set threshold value, and a “counter” (which may also be referred to as an “accumulator”) that measures the total number of voltage signals that exceed the pre-set threshold value, thus providing a total count of photons that impinge on the detector. The pre-set threshold is typically set to distinguish between “true” photon interaction event signals and electronic noise signals. Thus, a PC detector may have less noise than an energy integrating (EI) detector.

A spectral photon counting (SPC) detector is a type of PC detector that utilizes multiple pre-set threshold values to sort each of the detected voltage signals into different “bins” representing different energies of the incident photons. The read-out electronics of an SPC detector may sort incident photons into one or more energy bins by comparing the amplitudes of each of the detected voltage signals to a plurality of different threshold values. The total number of energy bins may be between 2 and 12 bins, for example. Thus, an SPC detector may provide both image information and measurements of the energy of the detected photons. An SPC detector may also be referred to as an energy-discriminating radiation detector.

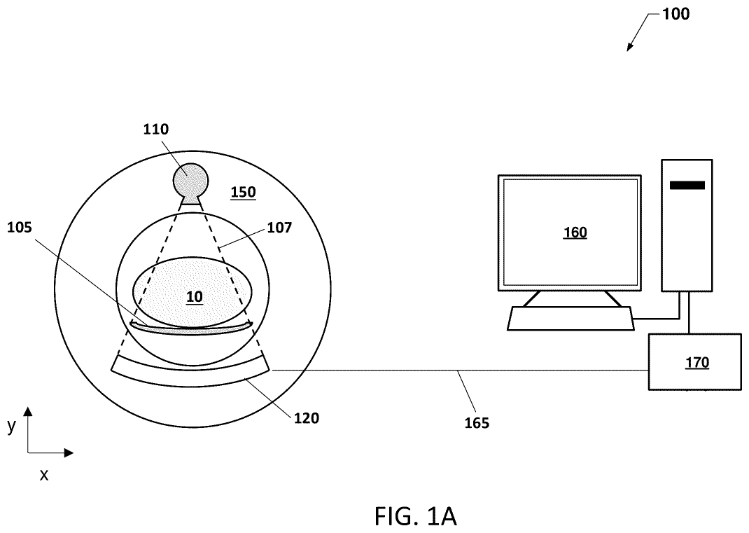

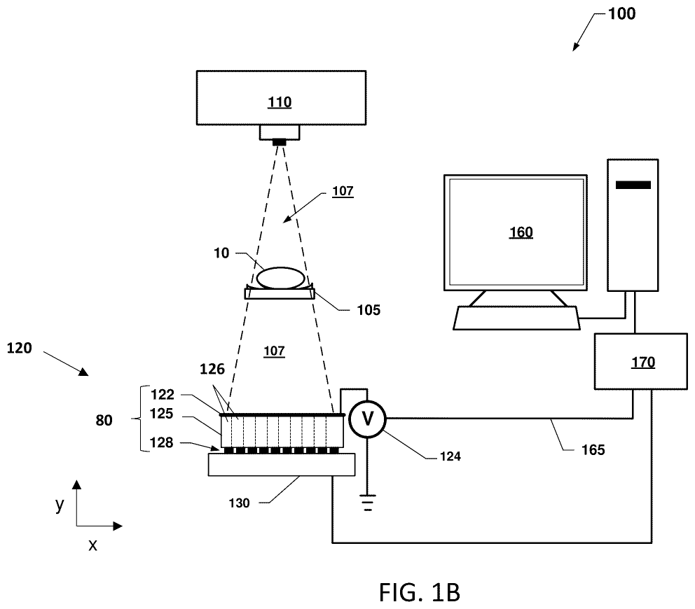

SPC detectors may be used for X-ray imaging applications, including for X-ray computed tomography (CT) imaging. FIGS. 1A and 1B are functional block diagrams of an X-ray imaging system 100 in accordance with various embodiments. The X-ray imaging system 100 may include an X-ray source 110 (i.e., a source of ionizing radiation), and a radiation detector 120, such as an above-described spectral photon counting radiation detector. The X-ray imaging system 100 may additionally include a patient support structure 105, such as a table or frame, which may rest on the floor and may support an object 10 to be scanned. In some embodiments, the object 10 may be a biologic subject (i.e., a human or animal patient). The support structure 105 may be stationary (i.e., non-moving) or may be configured to move relative to other elements of the X-ray imaging system 100, such as the X-ray source 110. For example, in a non-destructive testing imaging system, the support structure 105 may comprise a moving belt or web which supports the object 10. The object 10 may laterally translated by the moving belt or web past a stationary X-ray source 110, while the stationary detector 120 is located under the belt or web. The object 10 may comprise food, baggage, manufactured products, or any other object that is subject to non-destructive testing to determine the object's composition (e.g., whether the food contains impurities), contents (e.g., contents of baggage), and/or defects (e.g., defects in manufactured products).

As shown in FIG. 1A, the X-ray source 110 may be mounted to a gantry 150 (e.g., for CT imaging), or to another support, and may move or remain stationary (e.g., in non-destructive testing) relative to the object 10. The X-ray source 110 is configured to deliver ionizing radiation to the radiation detector 120 by emitting an X-ray beam 107 toward the object 10 and the radiation detector 120. After the X-ray beam 107 is attenuated by the object 10, the beam of radiation 107 is received by the radiation detector 120.

FIG. 1B illustrates further details of the radiation detector 120. The radiation detector 120 may be segmented or configured into a large number of small “pixel” detectors, as described in further detail below. The radiation detector 120 may include one or more radiation sensors 80 coupled to detector read-out circuitry 130. Each radiation sensor 80 may be controlled by a high voltage bias power supply 124 that selectively creates an electric field between an anode 128 and cathode 122 pair coupled thereto. In one embodiment, each radiation sensor 80 includes a plurality of anodes 128 (e.g., one anode per pixel) and one common cathode 122 electrically connected to the power supply 124 and facing the X-ray source 110. Each radiation sensor 80 may include a detector material 125, such as a semiconductor material disposed between the anode 128 and cathode 122 and thus configured to be exposed to the electrical field therebetween. The semiconductor material may comprise any suitable semiconductor material for detecting X-ray radiation disposed between the anode 128 and cathode 122 and thus configured to be exposed to the electrical field therebetween. In various embodiments, the semiconductor material of the radiation sensor(s) 80 may comprise a II-VI semiconductor material, such as cadmium telluride, cadmium zinc telluride (i.e., CdZnTe or “CZT”), cadmium selenide telluride, and cadmium zinc selenide telluride. Other suitable semiconductor materials are within the contemplated scope of disclosure.

The detector read-out circuitry may include one or more application specific integrated circuits (ASICs) 130. Each ASIC 130 may be coupled to one or more radiation sensors 80 and may receive signals (e.g., charge or current) from the anodes 128 of the radiation sensor(s) 80. Each ASIC 130 may be configured to provide data to and by controlled by a control unit 170. Each of the radiation sensors 80 may be segmented or configured into a large number of small “pixel” detectors 126. In various embodiments, the pixel detectors 126 of the radiation sensors 80 and the ASIC(s) 130 are configured to output data that includes counts of photons detected in each pixel detector 126 in each of a number of energy bins. Thus, the radiation detector 120 may provide both two-dimensional detection information regarding where photons were detected, thereby providing image information, and measurements of the energy of the detected X-ray photons. A radiation detector 120 that is capable of measuring the energy of the X-ray photons impinging on the detector 120 may be referred to as an energy-discriminating radiation detector 120.

The control unit 170 may be configured to synchronize the X-ray source 110, the read-out ASIC(s) 130, and the high voltage bias power supply 124. The control unit 170 may be coupled to and operated from a computing device 160. Alternatively, the computing device 160 and the control unit 170 may be integrated together as one device.

Referring to FIGS. 1A and 1B, in some embodiments, the X-ray imaging system 100 may be a computed tomography (CT) imaging system. The CT imaging system 100 may include a gantry 150, which may include a moving part, such as a circular, rotating frame with the X-ray source 110 mounted on one side and the radiation detector 120 mounted on the other side. The radiation detector 120 may have a curved shape along its long axis (i.e., the x-axis direction in FIG. 1A) such that each of the pixel detectors 126 along the length of the radiation detector may face towards the focal spot of the X-ray source 110. The gantry may also include a stationary (i.e., non-moving) part, such as a support, legs, mounting frame, etc., which rests on the floor and supports the moving part. The X-ray source 110 may emit a fan-shaped or cone-shaped X-ray beam 107 as the X-ray source 110 and the radiation detector 120 rotate on the moving part of the gantry around the object 10 to be scanned. After the X-ray beam 107 is attenuated by the object 10, the X-ray beam 107 is received by the radiation detector 120. The curved shape of the radiation detector 120 may allow the CT imaging system 100 to most effectively reject radiation scattered by the object 10.

For each complete rotation of the X-ray source 110 and the radiation detector 120 around the object 10, one cross-sectional slice of the object 10 may be acquired. As the X-ray source 110 and the radiation detector 120 continue to rotate, the radiation detector 120 may take numerous snapshots called “views”. Typically, about 1,000 profiles are taken in one rotation of the X-ray source 110 and the radiation detector 120. The X-ray source 110 and the radiation detector 120 may slowly move relative to the object (e.g., patient) 10 along a horizontal direction (i.e., into and out of the page in FIG. 1A) so that the radiation detector 120 may capture incremental cross-sectional profiles over a region of interest (ROI) of the object 10, which may include the entire object 10. The data acquired by the radiation sensor(s) 80 and output by the read-out ASIC(s) 130 may be passed along to the computing device 160 that may be located remotely from the radiation detector 120 via a connection 165. The connection 165 may be any type of wired or wireless connection. If the connection 165 is a wired connection, the connection 165 may include a slip ring electrical connection between any structure (e.g., gantry) supporting the radiation detector 120 and a stationary support part of the support structure, which supports any part (e.g., a rotating ring). If the connection 165 is a wireless connection, the radiation detector 120 may contain any suitable wireless transceiver to communicate data with another wireless transceiver that is in communication with the computing device 160. The computing device 160 may include processing and imaging applications that analyze each profile obtained by the radiation detector 120, and a full set of profiles may be compiled to form a three-dimensional computed tomographic (CT) reconstruction of the object 10 and/or two-dimensional images of cross-sectional slices of the object 10.

Various alternatives to the design of the X-ray imaging system 100 of FIG. 1A may be employed to practice embodiments of the present disclosure. X-ray imaging systems may be designed in various architectures and configurations. For example, an X-ray imaging system may have a helical architecture. In a helical X-ray imaging scanner, the X-ray source 110 and radiation detector 120 are attached to a freely rotating gantry. During a scan, the support structure (e.g., table) 105 moves the object 10 smoothly through the scanner, or alternatively, the X-ray source 110 and the radiation detector 120 may move along the length of the object 10, creating helical path traced out by the X-ray beam. Alternatively, in an orbital X-ray imaging scanner, the object 10 may remain stationary while the gantry rotates completely or partially around the object 10 (e.g., to image a heart or a brain in one revolution). Slip rings may be used to transfer power and/or data on and off the rotating gantry. In other embodiments, the X-ray imaging system may be a tomosynthesis X-ray imaging system. In a tomosynthesis X-ray scanner, the gantry may move in a limited rotation angle (e.g., between 15 degrees and 60 degrees) in order to detect a cross-sectional slice of the object 10. The tomosynthesis X-ray scanner may be able to acquire slices at different depths and with different thicknesses that may be reconstructed via image processing. Alternatively, the X-ray imaging system 100 may be a non-destructive testing system.

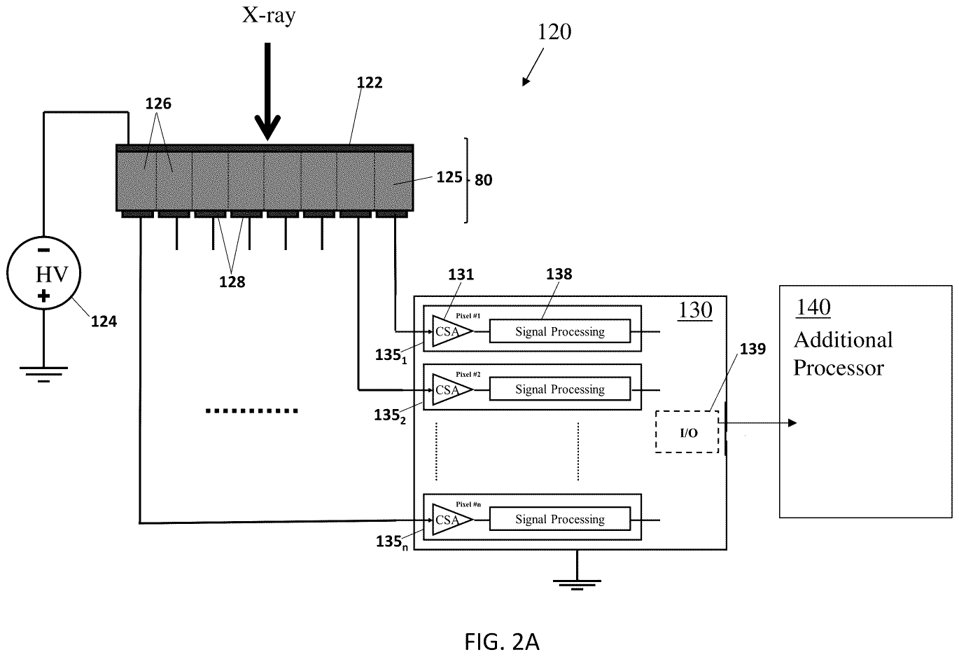

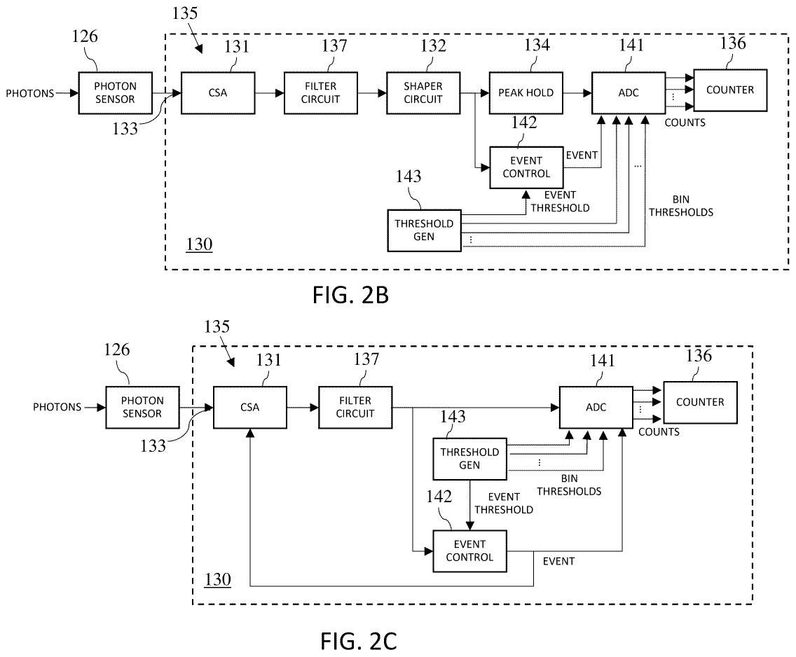

FIG. 2A schematically illustrates a radiation detector 120 including a pixelated radiation sensor 80 coupled to a detector application specific integrated circuit (ASIC) 130 according to various embodiments of the present disclosure. As discussed above, a high voltage bias power supply 124 may selectively create an electric field between an anode 128 and cathode 122 pair coupled thereto. In one embodiment, the radiation sensor 80 includes a plurality of anodes 128 and one common cathode 122 electrically connected to the power supply 124. Each of the anodes 128 may define a different pixel detector 126 of a pixelated radiation detector 120. The radiation sensor 80 may include a detector material 125 (i.e., a semiconductor material as described above) disposed between the anode(s) 128 and cathode 122 and thus configured to be exposed to the electrical field therebetween. In various embodiments, the radiation sensor 80 may be arranged such that the surface of the detector material 125 over which the cathode 122 is located faces towards the X-ray source 110 (see FIG. 1B). Thus, X-ray photons from the X-ray source 110 may impinge on the cathode-side of the radiation sensor 80.

An above-described detector application specific integrated circuit (ASIC) 130 may be coupled to the anode(s) 128 of the radiation sensor 80. The detector ASIC 130 may receive signals (e.g., charge or current) from the anode(s) 128) and be configured to provide data to and be controlled by a control unit 170 (see FIG. 1B). The signals received by the detector ASIC 130 may be in response to photon interaction events occurring within the radiation-sensitive semiconductor detector material 125. Accordingly, the signals received by the detector ASIC 130 may be referred to as “event detection signals.”

The detector ASIC 130 may include a semiconductor integrated circuit (IC) die that includes a substrate (e.g., a silicon substrate) and a plurality of circuit elements (e.g., transistors, resistors, capacitors, inductors, diodes, etc.) formed on, over and/or in the substrate. The circuit elements of the detector ASIC 130 may be configured to perform signal processing operations on event detection signals received from the anode(s) 128 of the radiation sensor 80. In particular, each anode 128 of the radiation sensor 80 may be electrically coupled to an input node of a respective signal processing chain or “channel” 135₁, 135₂, . . . 135ₙ, of the detector ASIC 130. Thus, in various embodiments, event detection signals from each anode 128 of the radiation sensor 80 may be processed by a separate channel 135₁, 135₂, . . . 135ₙ of the ASIC 130. Accordingly, the total number of signal processing channels 135₁, 135₂, . . . 135ₙ of the ASIC 130 may be at least as great as the total number of pixel detectors 126 of the radiation sensor(s) 80 that are coupled to the ASIC 130. Each of the channels 135₁, 135₂, . . . 135ₙ of the ASIC 130 may include a respective amplifier 131 and signal processing circuitry 138.

An ASIC 130 for a spectral photon counting (SPC) radiation detector 120 may include a plurality (e.g., hundreds or thousands) of identical or substantially-identical signal processing channels 135, as shown in FIG. 2A. Each channel 135 may be electrically coupled to an anode electrode 128 of a particular pixel detector 126 and may output photon count data of photon interaction events occurring within the particular pixel detector 126 over multiple energy bins. Referring again to FIG. 2A, the ASIC 130 may further include input/output (I/O) circuitry 139 that may be configured to transmit the photon count data from the ASIC 130 to another electronic component of the imaging system 100. In some embodiments, the I/O circuitry 139 may include high-speed I/O circuitry, such as low voltage differential signaling (LVDS) transmission circuitry.

Referring once again to FIG. 2A, in addition to the above-described ASIC 130, the read-out circuitry for the radiation detector 120 may include at least one additional processor 140, such as a field programmable gate array (FPGA). Other suitable processors are within the contemplated scope of disclosure. The at least one additional processor 140 may function as a downstream aggregator of photon count data output from the ASIC 130 and may optionally perform additional signal processing on the photon count data. In some embodiments, the at least one additional processor 140 may be used for configuration and control of the ASIC 130.

FIG. 2B is a block diagram schematically illustrating an analog signal chain architecture for one channel of a spectral photon counting (SPC) radiation detector according to various embodiments. Referring to FIG. 2B, the photon sensor (e.g., an above-described pixel detector 126) converts an incident X-ray photon to an electrical charge proportional to the photon energy. Detection signals (e.g., analog charge signals) from the photon sensor may be received at an input node 133 for the signal processing channel 135, which may be, for example, a bond pad located on a surface of the ASIC 130. The detection signals may be fed to an amplifier 131 that may be configured to convert the charge signal to a voltage signal. In some embodiments, the amplifier 131 may be a charge sensitive amplifier (CSA). The CSA may integrate the current to provide a voltage signal proportional to the photogenerated electron charge. The CSA may include a resistor in parallel with a feedback capacitor to limit the DC response. A filter circuit 137 may be included for pole-zero compensation of the CSA response. Alternatively, other types of amplifiers 131, such as a trans-impedance amplifier (TIA), may be utilized.

The signal processing channel 135 may additionally include a shaper circuit 132 that may be configured to “shape” the signal that is output by the amplifier 131. The shaper circuit 132 may convert the step-like filter output to a peaked form. The shaper circuit 132 may include a combination of first-order high-pass and low-pass filters, which may be referred to as an RCCR shaper. The output of the shaper circuit 132 may be processed by a peak hold circuit 134 to allow sampling by the analog to digital converter (ADC) 141.

The output of the shaper circuit 132 may also be provided to an event control block 142 that may be configured to generate a signal (i.e., an EVENT signal) when the output from the shaper circuit 132 exceeds an event threshold. When the EVENT signal is triggered, the ADC 141 may convert the signal to a digital format.

The threshold generator 143 may provide a plurality of threshold levels, including a first threshold level (also known as the trigger threshold level) used to indicate that a photon detection event has occurred, and one or more additional threshold levels (typically between 2 and 8 threshold levels), used to sort the detection signal into the relevant energy bin(s). For example, to detect photons having an energy over 20 keV, the first threshold level may be set at a threshold voltage, V_{TH0}, that is the equivalent of the signal produced by a 20 keV photon interaction event. The additional threshold levels may be set at threshold voltages, V_{TH1}, V_{TH2}, . . . V_{THn} used to define different ranges or “bins” of photon energies. The threshold voltages, V_{TH0}, V_{TH1}, V_{TH2}, . . . V_{THn}, may be determined using a calibration process. Thus, in an example where V_{TH0} corresponds to a cut-off reference photon energy of 20 keV, V_{TH1} corresponds to a cut-off reference photon energy of 50 keV, and V_{TH2} corresponds to a cut-off reference photon energy of 80 keV, photons having energies between 20-50 keV may be classified in a first energy bin, photons having energies between 50-80 keV may be classified in a second energy bin, and photons having energies >80 keV may be classified in a third energy bin.

The ADC 141 may convert the signal from the shaper circuit 132 to a digital format by comparing the signal received from the shaper circuit 132 to the series of threshold levels, and incrementing the count of detected photon interaction events within the relevant energy bin(s) of the counter/accumulator 136, which may sum the counts within each energy bin over time.

FIG. 2C is a block diagram schematically illustrating an alternative signal chain architecture for one channel of a spectral photon counting (SPC) radiation detector according to another embodiment. The architecture shown in FIG. 2C may be referred to as a switched-analog design. In this design, a shaper circuit 132 and/or a peak hold circuit 134 as described above with reference to FIG. 2B may be excluded. The signal from the amplifier 131 may be provided to a filter circuit 144, that may include a high-pass filter. The amplifier 131 (e.g., CSA) may be a switched integrator with only a capacitor in the feedback loop. This capacitor may be reset after an event occurs by closing a switch in parallel with the capacitor. When the event control block 142 event control generates an EVENT signal to indicate an event has occurred, the ADC 141 may sample the signal amplitude at a controlled time after the EVENT signal, allowing the filter circuit to reach its full amplitude. The ADC 141 may compare the signal amplitude to the plurality of threshold levels provided by the threshold generator 143, and the ADC 141 output may be routed to the counter/accumulator 136, which may sum the counts within each energy bin over time.

In some embodiments, a radiation detector 120 may have a modular configuration including a plurality of detector modules mounted on a common support structure, such as a detector array frame, to form a detector array (also known as a detector module system (DMS)) that includes a plurality of pixel detectors 126 extending over a continuous one-dimensional (1D) or two-dimensional (2D) detector array surface. Each detector module may include at least one above-described radiation sensor 80, at least one ASIC 130 electrically coupled to the at least one radiation sensor, and a module circuit board. The module circuit board may support transmission of electrical power, control signals, and data signals between the module circuit board and the at least one ASIC 130 and the at least one radiation sensor 80 of the detector module, and may further support transmission of electrical power, control signals, and data signals between the module circuit board and the control unit 170 of the X-ray imaging system 100, other module circuit boards of the detector array, and/or a power supply for the detector array.

In some embodiments, each detector module of the detector array (e.g., DMS) may itself be constructed from a set of radiation detector units, which may also be referred to as “submodules” or “mini-modules.” In some embodiments, each radiation detector unit may include at least one radiation sensor 80 that is physically and electrically coupled to an ASIC 130 configured to read out count data from the radiation sensor(s) 80 coupled thereto. A detector module may typically include a plurality of radiation detector units (or mini-modules (MMs)) mounted to a frame bar or other suitable support and electrically coupled to a module circuit board.

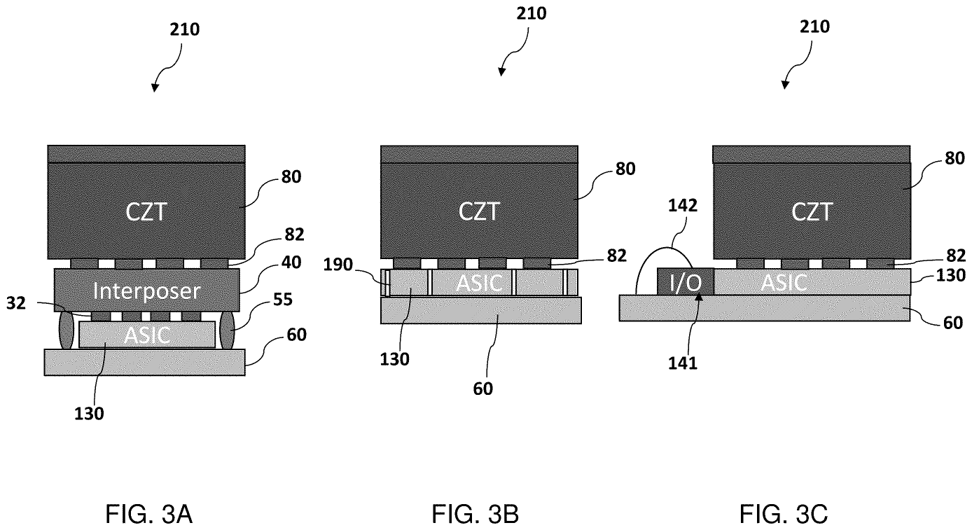

A number of different architectures may be used to integrate radiation sensors 80 with corresponding ASICs 130 to form radiation detector units (or mini-modules (MMs)). FIGS. 3A-3C are side cross-section views illustrating radiation detector units 210 having different architectures for integrating the radiation sensors 80 and ASICs 130. FIG. 3A illustrates a first radiation detector unit 210 in which one or more radiation sensors 80 is coupled to an ASIC 130 by an interposer 40 disposed between the radiation sensor(s) 80 and the ASIC 130. The embodiment of FIG. 3A includes a single radiation sensor 80 and a single ASIC 130, although it will be understood that a radiation detector unit 210 may also include multiple radiation sensors 80 and/or multiple ASICs 130. The interposer 40 may include a main body composed of one or more suitable insulating materials (e.g., semiconductor, glass, polymer (e.g., printed circuit board insulating laminate) and/or ceramic material) and conductive interconnect structures (not expressly shown in FIG. 3A) extending through and within the main body. The back side of the interposer 40 may have bonding pads that may be electrically connected to corresponding bonding pads on the front side of the ASIC 130 by first bonding structures 32, such as solder balls or copper pillars. The front side of the interposer 40 may have bonding pads that may be electrically connected to corresponding bonding pads (e.g., anode electrodes 128) on the back side of the radiation sensor 80 by second bonding structures 82, such as a low temperature solder material or conductive epoxy. As used herein, the “front side” of elements refers to the side that faces the incoming radiation, and the “backside” of elements refers to the side that is the opposite side of the front side. Detection signals from the radiation sensor 80 may be transmitted through second bonding structures 82, the conductive interconnect structures of the interposer 40, and the first bonding structures 32 to the ASIC 130. In some embodiments, the radiation sensor 80, interposer 40, and ASIC 130 may be located on a carrier board 60 (e.g., a PCB) that may handle input/output (I/O) signals for the radiation detector unit 210. The carrier board 60 may be electrically connected to the back side of the interposer 40 by third bonding structures 55, such as solder balls. Photon count data may be transmitted from the ASIC 130 to the interposer 40 and from the interposer 40 to the carrier board 60 by the third bonding structures 55. Power and control signals may be transmitted from the carrier board 60 to the interposer 40 via the third bonding structures 55, and then from the interposer 40 to the ASIC 130. The carrier board 60, in turn, may be connected to the module circuit board in the assembled detector module by a suitable connection, such as a flex cable connection (not shown in FIG. 3A). Further details and embodiments of radiation detector units 210 and detector modules 200 including an interposer 40 between one or more radiation sensors 80 and one or more ASICs 130 may be found, for example, in U.S. Pat. No. 11,067,707, which is incorporated by reference herein for all purposes.

FIG. 3B illustrates an alternative configuration of a radiation detector unit 210. In the radiation detector unit 210 of FIG. 3B, each radiation sensor 80 may be directly mounted to the front side of the ASIC 130 via a plurality of bonding structures 82, such as low temperature solder material or a conductive epoxy. In other words, each radiation sensor 80 is mechanically and electrically coupled to an ASIC 130 via the plurality of bonding structures 82, and no interposer 40 or similar intervening structural component for routing of electrical signals between the radiation sensors 80 and the ASIC 130 is located between the back side of each of the radiation sensors 80 and the front side of the ASIC 130. Such a configuration may be referred to as a “direct attach” radiation detector unit 210. Exemplary embodiments of “direct attach” radiation detector units 210 and detector modules 200 are described, for example, in U.S. patent application Ser. No. 18/468,891, filed on Sep. 18, 2023 (published as US Patent Application Publication 2024/0134071 A1), and U.S. patent application Ser. No. 18/158,695, filed on Jan. 24, 2023 (published as US Patent Application Publication 2023/0243985 A1), the entire teachings of both of which are incorporated by reference herein for all purposes.

The radiation detector unit 210 of FIG. 3B may further include a carrier board 60 as described above. The ASIC 130 may be disposed over the carrier board 60 such that the back side of the ASIC 130 may contact the front side of the carrier board 60. In some embodiments, a plurality of through-substrate vias (TSVs) 190 may be provided in the ASIC 130. The TSVs 190 may include an electrically conductive material (e.g., a metal material, such as copper) that extends between the front side and the back side of the ASIC 130. In embodiments in which the ASIC 130 may be formed on and/or in a silicon substrate, the TSVs 190 may also be referred to as “through-silicon vias.” Thus, signals between the carrier board 60 and the ASIC 130 may be transmitted through the back side of the ASIC 130. The carrier board 60 may be connected to the module circuit board 220 by a suitable connection, such as a flex cable connection, as described above.

FIG. 3C illustrates yet another example of a radiation detector unit 210 having a “direct attach” configuration. In the embodiment of FIG. 3C, the ASIC 130 may include a peripheral region 141 that extends beyond the outer periphery of the radiation sensor(s) 80. The peripheral region 141 may provide I/O connections for the ASIC 130. For example, a plurality of wire bond connections 142 may extend between the peripheral region 141 of the ASIC 130 and the front side of the underlying carrier board 60, as is described and illustrated in the above-referenced U.S. patent application Ser. No. 18/158,695.

As discussed above, a detector module is usually assembled by mounting a plurality of radiation detector units 210 or mini-modules (MMs) as shown in FIGS. 3A-3C onto a suitable support and electrically connecting each of the radiation detector units 210 to a common module circuit board. Control functionality (e.g., FPGA programming control) for the radiation detector units 210 is typically located on the module circuit board or elsewhere on the detector module. Thus, the radiation detector units 210 are normally not sold as a separate commercial product, but are instead interchangeable components used in mass production of detector modules and/or detector arrays (e.g., DMSs).

In the manufacturing of complex, multi-component products, such as a detector module and/or detector array for an imaging system, having the ability to accurately identify and trace the constituent parts of the product from sourcing to final assembly to post-sale monitoring and service is important for the purposes of effective quality control, regulatory compliance, failure analysis, and supply chain management. In the case of radiation detector units 210, these components themselves consist of multiple integrated parts, including an ASIC 130 permanently attached to one or more radiation sensors 80, and in some cases other components, such as a carrier board 60, flex cable assembly, interposer 40, or the like. However, there is no reliable way of providing identifying information for individual ASICs 130 and/or radiation detector units 210 that is both cost-effective and does not unduly interfere with the unit's functionality.

Normally, the ASICs 130 used in radiation detectors are manufactured using conventional complementary metal oxide semiconductor (CMOS) fabrication processes, and neither the ASIC 130 nor the radiation sensor(s) 80 bonded to the ASIC 130 have an embedded memory for permanently storing identifying information electronically. It is possible to design the ASIC 130 with a dedicated non-volatile data storage memory device, such as an EEPROM component, for storing identifying information related to the ASIC 130 and/or the radiation detector unit 210. Similar functionality might also be provided using polysilicon fuses (e.g., PROM) on the ASIC chip. However, such approaches would significantly increase manufacturing complexity and increase manufacturing costs, and could also interfere with the ASIC's read-out operations. Similarly, it may not be practical or cost-effective to physically mark the radiation detector units 210 with a unique identifier due to the relatively small size and fragile nature of these components.

Thus, there is a need for improved methods and systems that enable the identification of individual ASICs 130 and/or radiation detector units 210 in a cost-effective manner that does not risk damaging or otherwise negatively affecting the performance of either the ASIC 130 or the radiation detector unit 210 as a whole.

Various embodiments include methods and systems for providing unique identifiers for ASICs 130 and/or radiation detector structures including ASICs 130 (such as above-described radiation detector units 210) in a cost-effective manner. In various embodiments, the unique identifiers may be based on non-uniformities in the behavior and/or performance of the ASICs 130, such as small variations in the threshold voltages of the ADCs 141 within the signal processing channels 135 of the ASICs 130. Such non-uniformities are unavoidable by-products of the fabrication processes used to manufacture the ASICs 130 and also tend to be distributed in a random fashion throughout the different signal processing channels 135 of the ASIC 130. Thus, a unique identifier for each ASIC 130 and/or radiation detector unit 210 including an ASIC 130 may be derived from a characterization of the non-uniformities within the ASICs 130.

In some embodiments, the unique identifier may be derived from a calibration process performed on the ADCs 141 within the signal processing channels 135 of the ASICs 130. The calibration process may include determining the offset between the actual threshold voltages of the ADCs and their nominal threshold voltages, and applying ADC offset corrections to the ADCs to reduce or eliminate non-uniformities in the threshold voltages of the ADCs 141. The random nature of the ADC offset corrections across the different signal processing channels 135 of the ASICs 130 may be used to uniquely identify the ASICs 130 and/or the radiation detector units 210 including the ASICs 130.

It is known that variations in materials and/or processing conditions during fabrication of ASICs 130 produce small variations in the behavior and performance of the integrated circuits of the ASICs 130. Many of these variations do not noticeably affect ASIC 130 performance and can be ignored. However, some of these variations can result in meaningful differences in the performance and characteristics of different ASICs 130 and/or different signal processing channels 135 within the same ASIC 130. For example, the ADCs 141 (see FIGS. 2A-2B) within the signal processing channels 135 of the ASIC 130 often include small variations in their threshold voltages. For example, for ADCs 141 that include transistors (e.g., metal oxide semiconductor field effect transistors), the threshold voltages of the transistors may vary between different ADCs 141. These small variations in the threshold voltages of the ADCs can become significant due to the high gain (e.g., ~1000× or more) in the signal processing channels 135. Thus, inherent non-uniformities in the threshold voltages of different ADCs 141 of the ASIC 130 can cause the energy bin thresholds of different pixel detectors of the radiation detector unit 210 to vary by up to several keVs or more, which is generally not acceptable for SPC detectors.

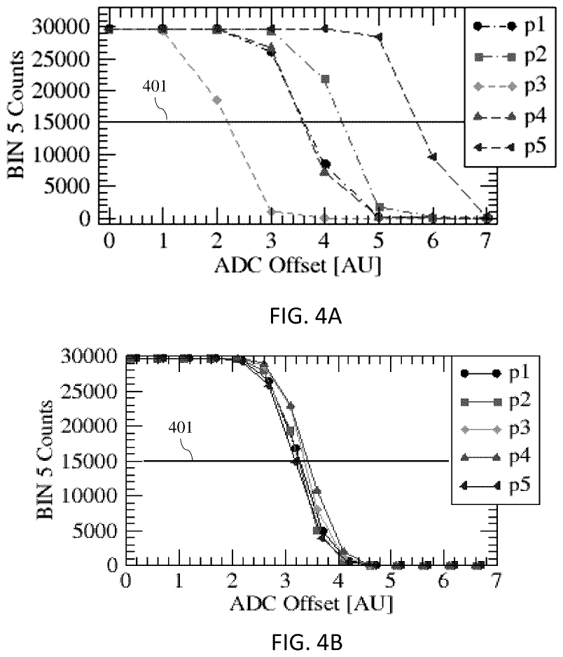

To address these inherent non-uniformities in the ADCs 141 of the ASIC 130, a calibration process may be performed to characterize the amount of variation in the different ADCs 141 (e.g., variation in ADC transistor threshold voltages) and to apply suitable corrections to enhance the uniformity of the threshold voltages of the ADCs 141. FIGS. 4A and 4B are plots that schematically illustrate an example calibration process for applying corrections to the ADCs 141 of an ASIC 130. The calibration process may include applying a series of electronic pulses to the signal processing channels 135 to simulate detection events at a desired photon energy while calculating different ADC offsets to the threshold voltage of the ADCs 141 of the signal processing channels 135. This process may be performed for all the signal processing channels 135 of the ASIC 130. The recorded count data for each energy bin may be plotted as a series of “S-curves” as shown in FIG. 4A, which illustrates the S-curves for five different signal processing channels 135 (p1 through p5). The ADC offset may be calculated from the S-curves using a calibration algorithm which includes determining the maximum count value, calculating the half the maximum count value (shown as line 401 in FIG. 4A), determining the voltage applied to the ASIC channel 135 that corresponds to the half the maximum count value 401, comparing the determined voltage to the rated (i.e., nominal) threshold voltage of the ADC 141 transistors of the ASIC channel 135, and then calculating the ADC offset for the ASIC channel 135 as a function of the difference between the determined voltage and the rated (i.e., nominal) threshold voltage. Although FIG. 4A illustrates eight (8) different ADC offsets, in practice a greater number of ADC offsets, such as 64 to 1024 ADC offsets, for example 256 to 512 ADC offsets may be utilized during the calibration. In addition, although for the purposes of clarity FIG. 4A depicts the S-curves for five different signal processing channels 135, a typical calibration process may include count data for all of the signal processing channels 135 of the ASIC 130.

In one non-limiting example, the calibration algorithm may include determining, for each ADC 141, the voltage at which the S-curve crosses the horizontal line 401 in FIG. 4A that corresponds to half the maximum count value (i.e., 15,000 Counts in FIG. 4A). The threshold voltage offset may be equal to the difference between the nominal threshold voltage of the ADC 141 and the voltage corresponding to the half-maximum count value. An ADC offset correction may be applied to shift the S-curve in either a positive direction (i.e., to the right in FIG. 4A) or in a negative direction (i.e., to the left in FIG. 4A) so that the S-curve of the ADC 141 crosses the half-maximum count line 401 at or close to the nominal threshold voltage of the ADCs 141. This is illustrated in FIG. 4B, which shows the S-curves for signal processing channels p1 through p5 following the application of the respective ADC offset corrections.

In various embodiments, the ADC offset correction may include adjusting the internal reference voltage of the ADC and/or injecting an offset voltage into the input signal path of the ADC to compensate for the threshold voltage offset. Typically, the ADC offset correction is applied in discrete steps, where each step consists of a specific voltage adjustment in either the positive or negative direction. Accordingly, the ADC offset correction may be expressed as a positive or negative integer value corresponding to the total number of discrete voltage adjustments made to the ADC 141. Thus, in the example shown in FIGS. 4A and 4B, the ADC offset correction value for channel p3 is a positive integer (thereby shifting the S-curve to the right) while the ADC offset correction values for channels p2 and p5 are negative integers (thereby shifting their S-curves to the left), where the magnitude of the ADC offset correction value of channel p5 is greater than that of channel p2.

A typical radiation detector unit 210 will often include hundreds or thousands of pixel detectors 126, each with a corresponding signal processing channel 135 in the ASIC 130 for reading-out the photon count data. In one non-limiting example, a radiation detector unit 210 may include two radiation sensors each including 864 pixel detectors mounted to an ASIC 130 with 1728 separate processing channels. Accordingly, the calibration process as described above would include a set of 1728 ADC offset correction values, each associated with a particular pixel location of the radiation detector unit 210. This set of ADC offset correction values may thus provide a unique signature for that particular ASIC 130 and/or radiation detector unit 210 that is extremely unlikely to be repeated in any other ASIC 130 and/or radiation detector unit 210.

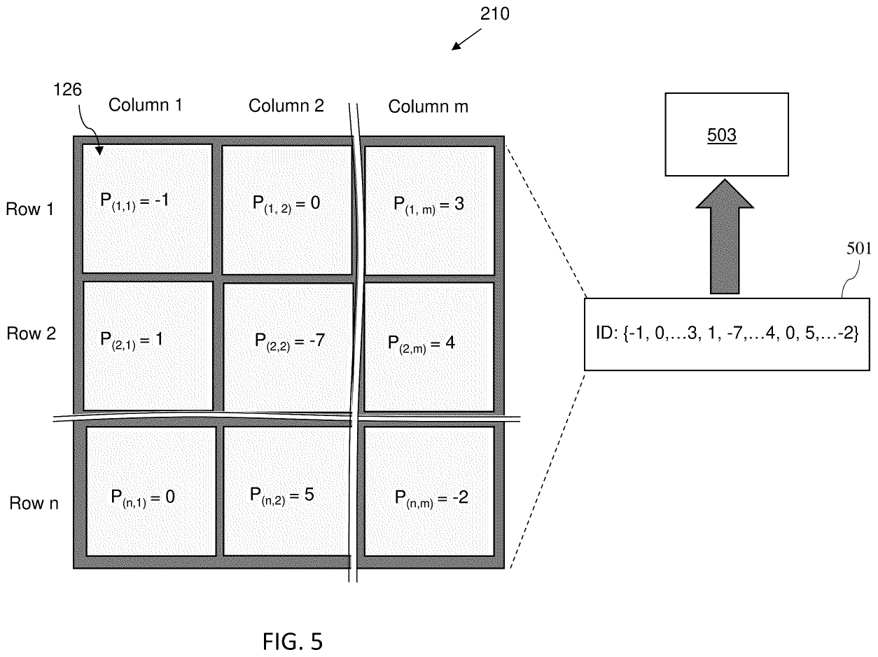

This is illustrated in FIG. 5, which is a top view of a radiation detector unit 210 including an n×m array of pixel detectors 126. As discussed above, each pixel detector 126 may be electrically coupled to a signal processing channel 135 of an ASIC 130 (not shown in FIG. 5). An above-described calibration process may be performed to generate ADC offset correction values for each signal processing channel 135 coupled to a corresponding pixel detector 126. FIG. 5 illustrates example ADC offset correction values for each of the pixel detectors 126. In one non-limiting embodiment, the ADC offset correction values may form a numeric string that includes all of the ADC offset correction values for the pixel detectors 126 of the array (e.g., from pixel detector P_{(0,0)} in the top left hand corner to pixel detector P_{(n,m)} in the bottom right hand corner of FIG. 5). This numeric string, which may be an integer string, may form a unique identifier 501 for the ASIC 130 and/or for the radiation detector unit 210 including the ASIC 130. In some embodiments, the unique identifier 501 may be stored in a storage device 503. The storage device 503 may be a remote storage device (i.e., external to the radiation detector unit 210), such as a central computer system maintained by and/or accessible to the manufacturer of the ASIC 130 and/or of the radiation detector unit 210. The unique identifier 501 may be generated and stored in the storage device 503 during an initial factory calibration. In some embodiments, the unique identifier 501 may be stored in association with other data related to the ASIC 130 and/or the radiation detector unit 210, such as date of manufacture, location of manufacture, lot number, product number, supplier information, inspection information, etc., that may be useful for component tracing purposes.

In some embodiments, the identifier 501 (e.g., numeric string) may also be stored locally at the imaging device 100. For example, each detector module may include a non-volatile memory (e.g., an EEPROM memory device), such as on the module circuit board, which may store the identifiers 501 for each radiation detector unit 210 of the detector module. Alternatively, or in addition, this information may also be stored in a central memory of the detector array (e.g., DMS) and/or of the imaging system 100 (e.g., in the computing device 160 shown in FIGS. 1A and 1B).

Although in the above-described example, the identifier 501 includes a numeric string including all of the ADC offset correction values for the pixel detectors 126 of the array, in other embodiments, the unique identifier 501 may be based on or derived from ADC offset correction values for the pixel detectors 126 but may not include all of the ADC offset correction values per se. For example, the identifier 501 may include a subset of the ADC offset correction values (e.g., the ADC offset correction values for every 2^{nd} pixel detector 126, every 5^{th} pixel detector 126, etc.). In some embodiments, the identifier 501 may be generated by performing one or more arithmetic and/or statistical operations on the set of ADC offset correction values. For example, the identifier 501 may be a numeric string including the sum or products of ADC offset correction values for pixel detectors 126 located in different regions (e.g., rows or columns) of the array. In other embodiments, the identifier 501 may include one or more root mean square (RMS) values of some or all of the ADC offset correction values.

In still further embodiments, the identifier 501 may include or may be based on the threshold voltage offsets of different ADCs 141 in the signal processing channels 135 determined during the above-described calibration process rather than the ADC offset correction values used to correct for variations in the threshold voltages of the ADCs.

An advantage of the above-described identification method is that the random variations in the threshold voltages of the ADCs 141 are an inherent characteristic of the ASIC 130. Thus, an ASIC 130 or radiation detector unit 210 in use in an imaging device may be readily identified by performing an additional calibration process as described above to determine the ADC offset correction values and/or threshold voltage offsets associated with different pixel detectors 126 of the radiation detector unit 210. The same process used to generate the original identifier 501 may then be repeated to generate an additional identifier that may be compared to previously-stored identifiers 501 (e.g., in a database maintained by the product manufacturer) to find a match that uniquely identifies the ASIC 130 and/or radiation detector unit 210. This permits relevant data pertaining to a particular ASIC 130 and/or radiation detector unit 210 to be readily obtained.

It is possible that the threshold voltages of the ADCs 141 within an ASIC 130 may shift slightly over time due to changes in temperature, positive supply voltage (V_{dd}) and the like. In such cases performing a subsequent calibration process may return slightly different values for the ADC offset corrections and/or the threshold voltage offsets of some or all of the pixel detectors 126 than the corresponding values from the initial calibration. However, even in cases where the ADC offset correction values and/or the threshold voltage offset values within an ASIC 130 do shift, they will generally shift uniformly and in the same direction (e.g., either positively or negatively). Based on this tendency, in some embodiments, an algorithm may be utilized to compare candidate identifiers 501 with known identifiers 501 to find the “best fit” using, for example, statistical analysis techniques in instances in which an exact match cannot be found.

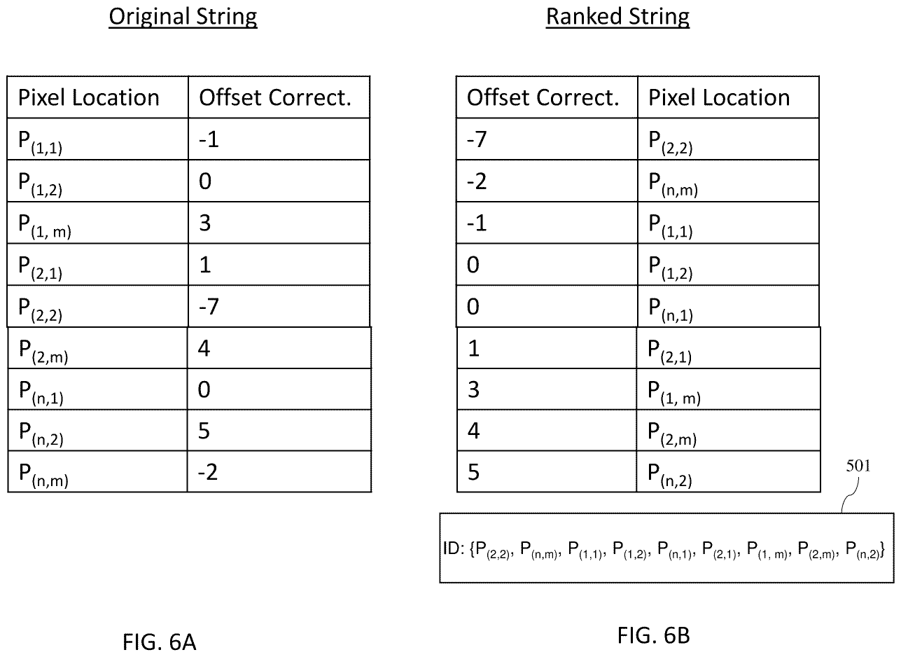

Alternatively, in some embodiments, the identifier 501 may be generated based on a ranking of the ADC offset correction values and/or the threshold voltage offset values. This is illustrated in FIGS. 6A and 6B, which are tables illustrating the ADC offset correction values for the nine pixel detectors 126 illustrated in FIG. 5. FIG. 6A shows the ADC offset correction values listed based on their pixel location (i.e., from P_{(0,0)} to P_{(n,m)}). The resultant numeric string of ADC offset correction values may then be ranked based on their respective values from lowest-to-highest or highest-to-lowest. This is illustrated in the table of FIG. 6B, which shows the ADC offset correction values ranked from the lowest value (i.e., −7, corresponding to pixel location P_{(2,2)}) to the highest (i.e., 5, corresponding to pixel location P_{(n,2)}). The identifier 501 may thus be based on the ranking of the pixel locations from lowest-to-highest (or alternatively, highest-to-lowest) ADC offset correction values. The identifier 501 may include, for example, a numeric or alpha-numeric string of the ranked pixel locations. In practice, each pixel location of the radiation detector unit may have an assigned number such that the identifier 501 may include a numeric string corresponding to the different pixel locations. Because the ADC offset correction values tend to shift uniformly in the same direction, the ranking of ADC offset correction values may remain consistent even when the actual values the ADC offset correction values shift over time.

Numerous variations of the ranking approach shown in FIGS. 6A and 6B may be utilized. For example, identifier 501 may be based on a ranking of one or more subsets of pixel detectors 126, such as a certain number of, or percentage of, pixel detectors 126 having the highest ADC offset correction values and/or the lowest ADC offset correction values. In another example, the identifier 501 may be based on a subset of pixel detectors having the highest magnitude of ADC offset correction values and/or the pixel detectors having ADC offset correction values that are a certain number of standard deviations from the mean ADC offset correction value. Thus, the identifier 501 may be based on the ADCs 141 having outlier threshold voltage offsets and offset correction values, which would tend to remain constant even as the actual ADC correction values may change over time.

In other embodiments, the identifier 501 may be based on the relationships between ADC offset correction values in adjacent pixel locations. For example, proceeding iteratively through all or a subset of the pixel locations, different numeric values may be assigned based on whether the ADC offset correction value of each pixel detector is greater than, less than, or equal to that of the pixel detector in the next pixel location of the array. These relationships would tend to remain constant even as the actual ADC offset correction values may vary.

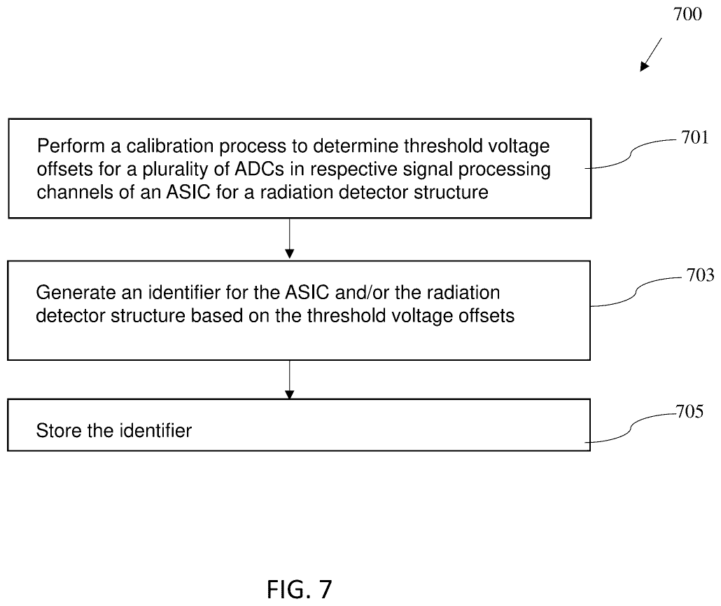

FIG. 7 is a flow diagram illustrating a method 700 of generating an identifier for a radiation detector structure 210 including an ASIC 130 according to various embodiments of the present invention. Referring to FIG. 7, in block 701 of method 700, a calibration process may be performed to determine threshold voltage offsets for a plurality of analog to digital converters (ADCs) 141 in respective signal processing channels 135 of the ASIC 130. In block 703 of method 700, an identifier 501 for the ASIC 130 and/or the radiation detector structure 210 may be generated based on the threshold voltage offsets of the plurality of ADCs 141. In block 705 of method 700, the identifier 501 may be stored. For example, the identifier 501 may be stored in a storage device in association with additional data related to the ASIC 130 and/or to the radiation detector structure 210.

Methods and systems of the embodiments of the present disclosure provide unique identifiers for radiation detector structures including ASICs. The unique identifiers may be based on non-uniformities in the ASICs, such as small variations in threshold voltages of the ADCs of the ASICs. In some embodiments, the unique identifier may be derived from a calibration process used to characterize and correct threshold voltage offsets of the ADCs. The random nature of the ADC offset corrections across different signal processing channels of the ASICs may be used to uniquely identify the radiation detector structures which may facilitate tracing of the radiation detector structures in a cost-effective manner.

The methods and systems of the embodiments of the present disclosure can be employed in connection with various radiation detection systems, such as computed tomography (CT) imaging systems. Any direct conversion radiation sensors may be employed, such as radiation sensors employing Si, Ge, GaAs, CdTe, CdZnTe, and/or other similar semiconductor materials.

The methods and systems of the present embodiments may be used for medical imaging, such as in Low-Flux applications in Nuclear Medicine (NM), whether by Single Photon Emission Computed Tomography (SPECT) or by Positron Emission Tomography (PET), or as radiation detectors in High-Flux applications as in X-ray Computed Tomography (CT) for medical applications, and for non-medical imaging applications, such as in baggage security scanning and industrial inspection applications.

While the disclosure has been described in terms of specific embodiments, it is evident in view of the foregoing description that numerous alternatives, modifications and variations will be apparent to those skilled in the art. Each of the embodiments described herein can be implemented individually or in combination with any other embodiment unless expressly stated otherwise or clearly incompatible. Accordingly, the disclosure is intended to encompass all such alternatives, modifications and variations which fall within the scope and spirit of the disclosure and the following claims.

1. A method of generating an identifier for a radiation detector structure including an application specific integrated circuit (ASIC), comprising:
performing a calibration process to determine threshold voltage offsets for a plurality of analog to digital converters (ADCs) in respective signal processing channels of the ASIC;
generating the identifier for at least one of the ASIC or the radiation detector structure based on the threshold voltage offsets of the plurality of ADCs; and
storing the identifier.

2. The method of claim 1, wherein:
the radiation detector structure comprises at least one radiation sensor comprising an array of pixel detectors;
the plurality of signal processing channels of the ASIC are electrically coupled to respective pixel detectors of the array of pixel detectors; and
each signal processing channel is configured to generate photon count data for a respective pixel detector of the array of pixel detectors.

3. The method of claim 2, wherein the identifier comprises a numeric string corresponding to threshold offset values of the plurality of ADCs in the signal processing channels of the ASIC.

4. The method of claim 2, wherein the performing the calibration process comprises applying ADC offset corrections to each of the ADCs to compensate for the threshold voltage offsets, wherein the identifier is based on ADC offset correction values applied to the ADCs.

5. The method of claim 3, wherein the identifier comprises a string of positive and negative integers corresponding to the ADC offset correction values applied to ADCs in the signal processing channels of the ASIC.

6. The method of claim 3, wherein the identifier is based on a ranking of the ADC offset correction values applied to a plurality of the ADCs from a highest-to-lowest value or a lowest-to-highest value.

7. The method of claim 6, wherein the identifier comprises a string of pixel detector locations corresponding to the ranking of the ADC offset correction values.

8. The method of claim 3, wherein the identifier is based on a relationship between the ADC offset correction values applied to ADCs in the signal processing channels electrically coupled to adjacent pixel detectors in the at least one radiation sensor.

9. The method of claim 2, further comprising assembling the radiation detector structure with one or more additional radiation detector structures on a support structure to provide a detector module.

10. The method of claim 1, wherein the identifier is stored in a storage device that is external to the radiation detector structure.

11. The method of claim 10, wherein the identifier is stored in a central computer system maintained by or accessible to a manufacturer of the at least one of the ASIC or the radiation detector structure.

12. The method of claim 11, wherein a plurality of the identifiers are stored in the central computer system, each of the plurality of identifiers are different from one another, and correspond to a different ASIC or a different radiation detector structure.

13. The method of claim 12, further comprising:
receiving a second identifier that is generated based on a second calibration process; and
matching the second identifier with an identifier of the plurality of identifiers stored in the central computer system.

14. The method of claim 2, wherein the radiation sensor comprises a semiconductor radiation sensor.

15. The method of claim 1, wherein the identifier is stored in association with additional data related to the at least one of the ASIC or the radiation detector structure in a storage device.

16. The method of claim 15, wherein the additional data comprises one or more of a date of manufacture, a location of manufacture, a lot number, a product identifier, supplier information, or inspection information.

17. A radiation detector structure, comprising
at least one radiation sensor comprising an array of pixel detectors;
an application specific integrated circuit (ASIC) comprising a plurality of signal processing channels, wherein: each of the signal processing channels contains an analog to digital converter (ADC), the plurality of signal processing channels of the ASIC are electrically coupled to respective pixel detectors of the array of pixel detectors, and each signal processing channel is configured to generate photon count data for a respective pixel detector of the array of pixel detectors; and
a storage device configured to store an identifier for the radiation detector structure, wherein the identifier is generated by performing a calibration process to determine threshold voltage offsets for a plurality of the ADCs in the respective signal processing channels of the ASIC, and generating the identifier for at least one of the ASIC or the radiation detector structure based on the threshold voltage offsets of the plurality of ADCs.

18. The radiation detector structure of claim 17, wherein the storage device is configured to store the identifier in association with additional data related to the at least one of the ASIC or the radiation detector structure.

19. The radiation detector structure of claim 18, wherein the additional data comprises one or more of a date of manufacture, a location of manufacture, a lot number, a product identifier, supplier information, or inspection information.

20. The radiation detector structure of claim 18, wherein the radiation sensor comprises a semiconductor radiation sensor.
